(19) United States
(12) Patent Application Publication
(10) Pub. No.: US 2018/0286371 A1
(43) Pub. Date: Oct. 4, 2018

(54) Article For Acoustic Absorption And Composite Material Comprising The Article

(71) Applicants: Alcatel-Lucent Ireland Ltd., Dublin (IE); Alcatel-Lucent USA Inc., Murray Hill, NJ (US)

(72) Inventors: Ian Davis, Delgany (IE); Todd Salamon, New Providence, NJ (US)

(73) Assignees: Alcatel-Lucent USA Inc., Murray Hill, NJ (US); Alcatel Lucent, Boulogne-Billancourt (FR)

(21) Appl. No.: 15/475,570

(22) Filed: Mar. 31, 2017

(51) Int. Cl. G10K 11/04; G10K 11/168

(52) U.S. Cl. CPC G10K 11/04; G10K 11/168

(57) ABSTRACT

An article comprises an elastic membrane having a mass element provided thereon the mass element having an asymmetric shape and a resonator structure having a resonance frequency. The elastic membrane is configured to oscillate in response to a sound wave incident thereon, and the asymmetry of the mass element is configured to induce a flapping motion which in combination with the oscillation of the membrane trap vibrational mechanical energy from the sound wave and the resonator structure is configured to absorb at least a part of the incident sound wave. A composite material comprising the article is also disclosed.

### TECHNICAL FIELD

The present disclosure is directed, in general, to acoustic absorption techniques.

### BACKGROUND

This section introduces aspects that may help facilitate a better understanding of the present disclosure. Accordingly, the statements of this section are to be read in this light and are not to be understood as admissions about what is in the prior art or what is not in the prior art.

The current generations of telecommunication equipment are typically designed to process very high rates of data in comparatively very small physical volumes. Such equipment are therefore often faced with extremely high and difficult cooling challenges. Various solutions have been proposed, among which, some include the use of fans to cool the environment enclosed within the equipment.

### SUMMARY

Some embodiments feature an article comprising:
an elastic membrane having a mass element provided thereon, the mass element having an asymmetric shape; and
a resonator structure being totally or partially hollow and located between a hard surface and the mass element, the resonator structure having a resonance frequency;
wherein the elastic membrane is configured to oscillate in response to a sound wave incident thereon, and the asymmetry of the mass element is configured to induce a flapping motion which in combination with the oscillation of the membrane trap vibrational mechanical energy from the sound wave; and
wherein the resonator structure is configured to absorb at least a part of the incident sound wave.

According to some specific embodiments, the article comprises a surface configured to reflect incident sound waves towards the resonator and the elastic membrane.

According to some specific embodiments the article comprises a spring configured to exert a force on the elastic member in a direction opposite to a direction of oscillation of the membrane.

According to some specific embodiments, the article comprises a dampener configured to cooperate with the spring to damp the oscillation of the membrane.

According to some specific embodiments, the mass element is magnetic or ferrous and the article comprises a fixed magnet; wherein the article is configured to damp a motion of the mass element relative to the fixed magnet by an effect of a magnetic force between the mass element and the fixed magnet.

According to some specific embodiments, the mass element is hollow and comprises at least one of a fluid, a viscoelastic material and a plurality of suspended particles, the article being configured to damp a motion of the mass element by a drag effect caused by the fluid, the viscoelastic material, the plurality of suspended particles, or a combination thereof.

According to some specific embodiments, the article comprises at least two elastic membranes each having a respective mass element thereon, wherein a first elastic membrane is configured to oscillate at a first resonant oscillation frequency in response to an acoustic wave incident thereon and a second elastic membrane is configured to oscillate at a second resonant oscillation frequency in response to an acoustic wave incident thereon, and wherein said first resonant oscillation frequency is different from said second resonant oscillation frequency.

According to some specific embodiments, the mass element of the first elastic membrane is mechanically coupled to the mass element of the second elastic membrane.

According to some specific embodiments, the mass element of the first elastic membrane has physical characteristics that are different from physical characteristics of the mass element of the second elastic membrane.

According to some specific embodiments, the mass element is magnetic and the article further comprises a conductive coil at least partially surrounding the mass element; wherein the article is configured to induce a current inside the coil in response to an oscillation of the magnetic mass element provided on the membrane.

According to some specific embodiments, the article further comprises an energy harvester circuit configured to collect electric energy produced by the induction of current in the coil.

According to some specific embodiments, induction of current in the coil is dissipated as heat in the coil.

According to some specific embodiments, the article comprises a resistor electrically connected to the coil and configured to dissipate the electric energy through heat.

According to some specific embodiments, the mass element is a first electric conductor and the article further comprises a second electric conductor, wherein the first electric conductor and the second electric conductor form respective electrodes of a capacitor and the article further comprises an electric energy dissipater and an electric power supply the capacitor is configured to produce a change in charge stored in the first electrode and the second electrode, wherein such change in charge induces an oscillating current through the electric energy dissipater thereby dissipating the energy in the form of heat.

According to some specific embodiments, the elastic membrane is attached at end regions thereof to a supporting frame structure.

According to some specific embodiments, the elastic membrane is attached to one or more adjacent elastic membranes.

In some embodiments the elastic membrane comprises perforations to allow pressure relief and/or viscous dissipation from air movement through the perforations.

Some embodiments feature a composite material, comprising:
a layer of an acoustically transparent, airflow resistant material configured for preventing penetration of airflow;
a layer of bulk absorptive material configured to absorb noise in a first frequency range
a layer comprising an article, including:
an elastic membrane having a mass element provided thereon, the mass element having an asymmetric shape; and
a resonator structure being totally or partially hollow and located between a hard surface and the mass element, the resonator structure having a resonance frequency;
wherein the elastic membrane is configured to oscillate in response to a sound wave incident thereon, and the asymmetry of the mass element is configured to induce a flapping motion which in combination with the oscillation of the membrane trap vibrational mechanical energy from the sound wave; and
wherein the resonator structure is configured to absorb at least a part of the incident sound wave.

According to some specific embodiments, the bulk absorptive material comprises a second resonator structure configured to absorb the incident sound wave.

In some embodiments the elastic membrane comprises perforations configured to allow for pressure relief and/or viscous dissipation from air movement through the perforations.

In some embodiments the composite material comprises a hard surface provided at a location downstream the layer comprising an article in a direction of propagation of the sound waves

In some embodiments hard surface comprises perforations configured to allow for pressure relief.

### BRIEF DESCRIPTION OF THE DRAWINGS

The embodiments of the disclosure are best understood from the following detailed description, when read with the accompanying figures. Various features may not be drawn to scale and may be arbitrarily increased or reduced in size for clarity of discussion. Reference is now made to the following descriptions taken in conjunction with the accompanying drawings, in which:

FIG. 1 is a schematic example of a composite material according to some embodiments.

FIG. 2 is a schematic example of a cell comprised in an article according to some embodiments.

FIG. 3 is a schematic example of a cell comprised in an article according to some embodiments.

FIG. 4 is a schematic example of a cell comprised in an article according to some embodiments.

FIG. 5 is a schematic example of a cell comprised in an article according to some embodiments.

FIG. 6 is a schematic example of a cell comprised in an article according to some embodiments.

FIG. 7 is a schematic example of a cell comprised in an article according to some embodiments.

FIG. 8 is a schematic example of a cell comprised in an article according to some embodiments.

### DETAILED DESCRIPTION OF ILLUSTRATIVE EMBODIMENTS

As mentioned above, current telecommunication equipment are typically designed to process very high rates of data in comparatively very small physical volumes which makes the task of cooling the components located inside the equipment quite complex and challenging. For example in some telecommunication equipment more optical components such as CFP4 modules (CFP standing for C form-factor pluggable) and electrical components such as high-power ASICs (application-specific integrated circuit) are being placed within existing footprints. The shelf units which carry such equipment are typically exclusively air cooled by trays of fans.

Improvements in fan design have been able to optimize fan airfoil geometries and motor efficiencies, however this trend has reached a point where breakthroughs in fan design seem to be rare. Therefore, typically only marginal aerodynamic and acoustic improvements are achievable, whereas the volumetric flow rate requirements for telecoms equipment continues to rise. This means that fans would need to be driven at higher rotational speeds to maintain sufficient cooling, leading to a significant rise in acoustic emissions. This problem may cause products to be rejected certification due to acoustic sound power levels being above the allowable limits, for example as set out by ETSI standards (72 dBA). For reference, a change in sound power of 10 dBA may correspond to a change of an order of magnitude in Watts.

In order to remedy the above problem, one solution may invole requesting fan suppliers to provide custom designed fans which would emit a lower level of noise. However, this solution usually involves an increase in the cost of final product and may cause delays in launching of new products. Furthermore, this solution is usually only marginal as it may not reduce sound levels more than 1-2 dBA, unless highly-specialized blower technology is used which can achieve up to 10 dBA reductions. However, employing such customized and highly-specialized technologies would typically result in significant engineering and design cost overhead.

Another prospect for noise reduction is to redesign airflow paths through the shelf system in order to reduce impedances to the air flow, therefore increasing the air flow rate though the system for a given fan speed. This further adds time in redesigning the shelf and cost in potentially delaying full-scale production and product launch.

An alternative solution for mitigating acoustic noise is to introduce acoustic absorption to dissipate acoustic energy through other mechanisms such as heat. This allows noise levels to be reduced without modifying the existing shelf design or choice of fans.

Some conventional methods of acoustic absorption apply bulky fibrous or poroelastic materials in the acoustic propagation path. These materials have absorption capabilities dependent on the thickness of the material relative to the acoustic wavelength of the noise entering the material.

Typically, the thickness of the materials should be close to, or beyond, the acoustic wavelength at a given frequency in order to provide significant attenuation. In some of the known poroelastic acoustic absorption materials in order to significantly attenuate noise at frequencies below 1 kHz, the material thicknesses may need to be above 30 mm. This is problematic as fans generate a large amount of low-frequency noise below 1 kHz. Given the tight space constraints in shelf designs, such a volume of material will either further constrain the airflow path and increase the airflow impedance in the system, or it will add to the total volume requirements of the shelf design.

Furthermore, both porous foams and fibrous materials may have respiratory health concerns associated with them, and flammability requirements will further restrict the choice of materials.

Beyond bulk absorption materials, more recent developments in sound absorption research have focused on metamaterial structures that can provide significant absorption for wavelengths far larger than the thickness of the material i.e. sub-wavelength absorption.

Employing metamaterial structures to reduce acoustic noise is another known solution. For example, an elastic membrane may be used with embedded asymmetric platelets capable of providing absorption at frequencies as low as 160 Hz despite having a thickness of only 1/600th the acoustic wavelength. The on-coming acoustic wave normal to the membrane surface strongly excites resonance modes in the metamaterial at a range of frequencies. These resonance frequencies correspond to the excitation of translational and rotational flexural motion of the embedded platelets as well as vibration of the elastic membrane. Since these modes couple very poorly to any modes of acoustic propagation, the energy is trapped inside the membrane, where it is dissipated as heat via friction. As a result of this, significant levels of acoustic noise are absorbed at or near these resonance frequencies. One such metamaterial structure is known from Mei, et al, “Dark acoustic metamaterials as super absorbers for low-frequency sound”; Nature Communications; DOI: 10.1038; 2012.

Embodiments of the disclosure feature an article for acoustic absorption and a composite material comprising said article so as to provide optimal acoustic noise absorption across a wide frequency range.

Herein the term system is to be understood to refer to any device, apparatus or equipment or any combinations thereof which includes the composite material of the present disclosure.

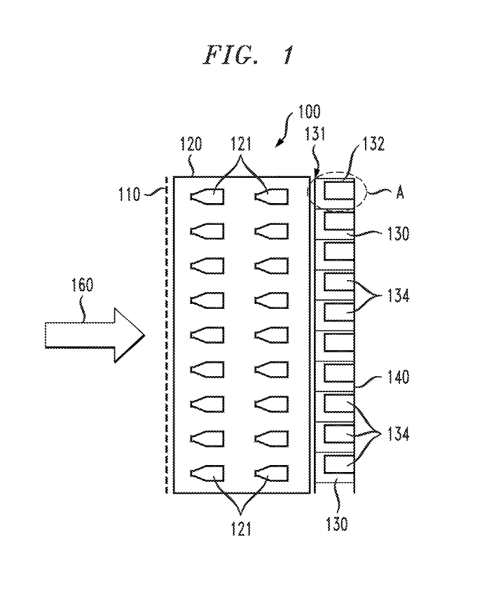

FIG. 1 illustrates a schematic example of a composite material 100 according to some embodiments. As shown, the composite material comprises a structure with various layers which in combination are capable of providing optimized acoustic absorption across a broad frequency range.

The structure of the composite material 100 comprises at least four layers as described below. It is to be noted that the use of the adjectives, first, second, third and fourth in reference to the layers is merely intended to facilitate the understanding of the present disclosure and is not to be construed as limiting the position of the layers to any specific order.

A first layer 110 comprises an Acoustically Transparent, Airflow Resistant (ATFR) material. This ATFR layer 110 is configured for preventing airflow from penetrating further layers within the structure of the composite as such penetration could negatively affect the absorption performance of the structure and cause undue stress on these layers. ATFR as known in the related art comprises woven fibrous materials that can form an aerodynamically-closed boundary which demonstrate high (˜90%) acoustic transmission. Some non-limiting examples of material usable as AFTR 110 are Kevlar® cloth (Kevlar® is a registered trademarks of E.I. du Pont de Nemours and Company), carbon fiber cloth and glass fiber cloth.

A second layer of bulk absorptive material 120 is configured to absorb noise in the mid-high frequency range for example from 1 kHz to 20 kHz. The layer of bulk absorptive material 120 may be selected from materials such as for example, melamine foam, polyurethane foam, bundled hemp fibers or other materials known in the related art. The amount of absorption may depend on the thickness of the material. The thickness of this layer may be adjusted depending on the volume constraints of the application.

Preferably the layer of bulk absorptive material 120 comprises resonators 121 to provide additional absorption in a narrow frequency band. Non-limiting examples of resonators 121 are Helmholtz or split-ring resonators as known in the related art.

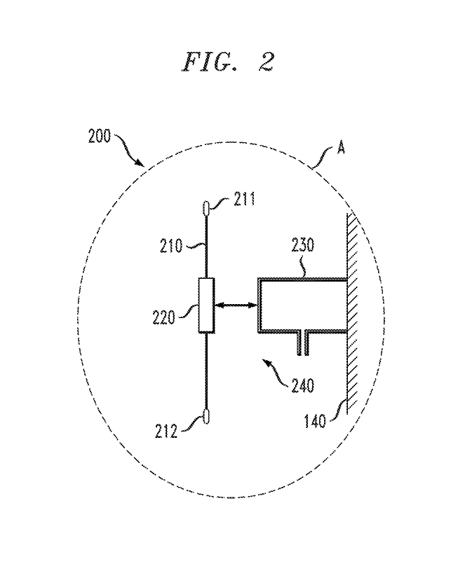

A third layer 130 relates to an article comprising a membrane-type metamaterial structure 131 with a backing air gap structure 132 configured to provide low-frequency absorption, e.g. about or below 1 kHz. The backing air gap structure 132 is intended to provide additional narrowband absorption of any noise which may propagate though the membrane-type metamaterial structure 131. The backing air gap structure 132 may comprise resonators 134. A non-limiting example of such resonators is a Helmholtz resonator. Further detailed description regarding the third layer 130 is provided below with reference to FIGS. 2 to 8.

A fourth layer 140 comprises a surface preferably made of hard (i.e. rigid) material. This hard surface 140 is provided at a location downstream the third layer in the direction of propagation of the sound waves 160 and is configured to reflect, as much as possible, any acoustic noise which may have passed through the previous layers 110, 120 and 130 without being absorbed. The reflection of such unabsorbed acoustic nose may cause such noise to be propagate back through the layers 130, 120 and 110, thus providing still additional absorption actions.

One significant advantage of the above structure of the composite material 100 is that the different layers employed in such structure may absorb different, or overlapping, ranges of frequencies of the acoustic noise, therefore providing a wide range of frequencies that may be absorbed by the overall structure.

As mentioned above the third layer 130 is an article which comprises a membrane-type metamaterial structure 131. The general concept of metamaterial structures is known, for example from the reference cited above. One example of such structures may comprise a plurality of elements (represented by reference A in FIG. 1) typically positioned in the form of two-dimensional arrays (although three-dimensional structures may also be made) forming an assembly which is capable of providing outstanding properties which are different from natural properties otherwise available. In the present case, the metamaterial structure may be arranged in repeating patterns of such elements, at scales (either individually or the entire array) that are smaller than the wavelengths of the phenomena they influence.

The metamaterial article of the third layer 130 as proposed herein comprises elements arranged in arrays wherein each element has structural and functional properties not known in the related art.

In FIG. 2 one element 200, herein referred to as cell, of the metamaterial is shown in some detail. This cell 200, also represented by reference A, corresponds to the cell A shown in FIG. 1. It will be appreciated that a plurality of the cells 200 provided in a specific arrangement such as for example rows and columns constitute the metamaterial structure as referred to herein.

Cell 200 comprises an elastic membrane 210. The elastic membrane 210 may be attached at end regions thereof to attachment points 211 and 212 such that in response to a mechanical disturbance, e.g. impact of sound waves, the membrane 210 may oscillate.

In some embodiments, the attachment points 211, 212 may be located on a support structure such as frame not explicitly shown in FIG. 2.

In some embodiments, the attachment points 211, 212 may be points of attachment between two adjacent membranes. In this case, there may be no need for a support structure such as a frame to sustain each membrane, but the adjacent membranes 210 sustain each other (although some type of rigid sustainment may still be needed in the circumference of the metamaterial structure 131.

The membrane 210 may be made of any known material such as silicone, polyamide, nylon or any non-woven material which can be made into thin layers, e.g. about 100 microns.

The membrane 210 may have any suitable shape, e.g. square, rectangular, triangular, hexagonal, which would all allow for providing a tiling plane for the metamaterial 131.

Cell 200 further comprises a mass element 220 provided on the membrane 210. The mass element 220 may be provided on the membrane 210 in any known manner, e.g. by using adhesive or by thermally bonding them to the membrane. Other approaches may comprise embedding the mass element within the membrane or providing the mass element sandwiched between two membranes attached together.

The mass element 220 has asymmetric shapes. Such shape may have any form as long as such asymmetry is present.

Herein the term “asymmetric” and related expressions are to be understood to refer to any shape having asymmetry at least along one line, axis or plane, even if such shape defines symmetry in another line, axis or plane.

The mass element 220 may be made of any suitable material (some non-limiting examples are provided below with reference to the various embodiments of the present disclosure). The mass element 200 is chosen so as to have different physical properties as compared to those of the membrane 210 so as to exhibit different responses to the impact of incident sound waves, as further described below.

In some embodiments the mass element associated with a cell may comprise multiple individual bodies of masses associated with the same cell, where the individual bodies of masses may be of similar or different characteristics, e.g. weight, size, shape, material.

The arrangement comprising the elastic membrane 210 and the mass element 220 provide a structure capable of damping incident sound waves. The sound waves mechanically excite vibration (or oscillation) in the membrane, which couple to specific vibrational modes at resonance frequencies. Because of the asymmetry of the mass element, and the contrast in physical properties between the mass element and membrane, kinetic energy associated with the vibration is trapped in asymmetric mode shapes. That is, the membrane oscillates in response to the sound wave incident thereon, and the asymmetry of the mass element causes a flapping motion of the mass element.

These vibrational modes couple very weakly with acoustic modes upstream or downstream of the membrane, thus the kinetic energy remains trapped in the membrane. The damping thus includes trapping the kinetic energy of the sound waves in the membrane and dissipating it in the form of heat which results in the absorption of such sound waves by the membrane 210.

Cell 200 further comprises a resonator structure 230 (also referred to as resonator) surrounded by an air gap 240 within the cell 200. The resonator structure may be totally or partially hollow and may be mounted on the hard surface 140. In some embodiments, the mass element 220 is mechanically coupled to the resonator 230.

The air gap 240 as referred to herein comprises the air environment present between the hard surface 140 with the resonator located thereon and the elastic membrane 210. The air gap 240 itself may also have a damping effect on the mechanical disturbance caused by the acoustic noise. A reactance provided by the air gap 240 affects the acoustic impedance of the system, thus improving the absorption performance of the metamaterial.

Herein, the term reactance is to be understood to refer to the imaginary part of a complex impedance. The real part of the impedance, the resistance, shows the amount of the acoustic energy that will be lost due to losses such as viscous dissipation which do not affect the phase of the wave; whereas, reactance is an indication of how sound is attenuated by the interaction between incident and reflected sound, for example losses or amplifications due to constructive or destructive interference.

The resonator 230 may be sized so as to resonate at certain desired frequencies. In this manner it may act as a backing structure for additional noise absorption. Therefore, any sound wave which may propagate through the elastic membrane 210 and has a frequency which is different from the resonance frequency of the resonator 230 may undergo additional absorption when reaching the resonator 230. The resonator 230 may be of any known type such as for example a Helmholtz resonator.

Optionally the resonator 230 may include additional absorbing material installed within the body of the resonator to improve absorption performance.

In a metamaterial structure, comprising an array of cells 200, membranes of different sizes and shapes may be used as long such differences in size and shape still allow for providing an overall plane having the array of membranes, for example a Penrose tiling of the membrane with an aperiodic set of shapes.

Likewise, in a metamaterial, comprising an array of cells 200, the mass elements may have different sizes and shapes with the array, also as long such differences in size and shape still allow for providing an overall plane having the array of membranes having the mass elements thereon, for example a Penrose tiling of the membrane with an aperiodic set of shapes.

In some embodiments, the metamaterial structure may comprise an array of cells 200 and one membrane may be common to various cells. Therefore, in this embodiment, one membrane may be extended over more than one cell wherein each cell comprises a support structure to which respective portions of the common membrane are attached to thereby define, in combination with each individual support structure, a cell. Therefore, while the membrane may be extended over various cells, each portion of the membrane associated with a cell (and the respective support structure) may comprise a mass element and be configured to oscillate within the respective cell. The support structures, and thus the cells, may be of any suitable sizes and shapes. Furthermore, individual cells in one metamaterial structure may have sizes and shapes that are different from each other.

In some embodiments the hard surface 140 may comprise perforations to allow pressure relief, should such relief be desired.

In some embodiments the membrane 210 may comprise perforations to allow pressure relief and/or viscous dissipation from air movement through the perforations.

FIG. 3 illustrates a schematic example of a cell 200 for use in an article which may be employed in the composite material 100 according to some embodiments. In FIG. 3, like elements have been provided with like reference numerals as those of FIG. 2.

Referring to FIG. 3, cell 200 comprises an elastic membrane 210, a mass element 220 which may be a small plate-like body (i.e. a platelet) embedded on the membrane 210, a resonator 230 mounted on a hard surface 140 where an air gap 240 is present surrounding the resonator 230. Except for the specific features described below, the structural and operational characteristics of the cell 200 of FIG. 3 are similar to that of the cell 200 of FIG. 2; therefore additional description thereof is considered not necessary.

In the embodiment of FIG. 3, the cell 200 further comprises a spring 251.

In operation when sound waves 260 impact the membrane 210 the mechanical disturbance associated with such impact causes the membrane 210 to oscillate. The oscillation of the membrane with the mass element 220 thereupon is transferred to the spring 251 in the form of compression or extension of the latter. In response, the spring 251 exerts an opposite force to the membrane/mass assembly resulting in a damping effect on the oscillation of the membrane 210. The illustrated single cell 200 is representative of a potentially more complex, multiple-DOF system which comprises a plurality of cells 200 in the metamaterial structure forming the article of the third layer 130 (FIG. 1). This system is capable of influencing the potential modes of flexural motion of the metamaterial structure 130. At specific modal excitation frequencies, energy from the incident sound will be trapped inside the cell 200 and dissipated via viscous dissipation in the membrane and dampened spring system.

The orientation and stiffness of the spring 251, geometry and locations of the mass element 220, and material properties and tension of the elastic membrane 210 may all be modified to affect the flexural response of the membrane structure to the on-coming acoustic wave. This will in turn affect the resonance and anti-resonance modal frequencies of the membrane and therefore may be used to tune the membrane for a desired absorption/reflection response.

The cell 200 may optionally comprise a dampener 252, for example a dashpot. The dampener may be configured to provide additional damping effect to that provided by the spring 251 to thereby assist the overall damping response of the cell 200.

The spring 251 and the dampener 252 may be installed in parallel as shown in FIG. 3, or they may be installed in serial configuration (not explicitly shown in FIG. 3). The dampener 252 may be based on hydraulic or magnetic configurations.

As mentioned with reference to FIG. 2, the resonator 230 may be used to further absorb the acoustic noise at frequencies which are different from the resonance frequency of the resonator 230. The frequency response of the resonator 230 may be tuned depending on the resonator geometry to maximize absorption in a desired frequency range, particularly at frequencies where it is predicted that the membrane 210 may not act as an effective absorber.

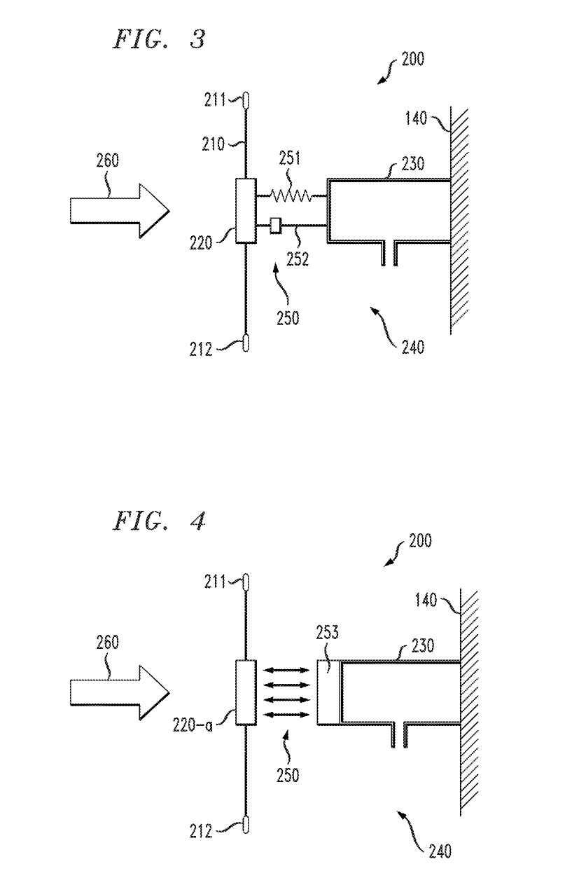

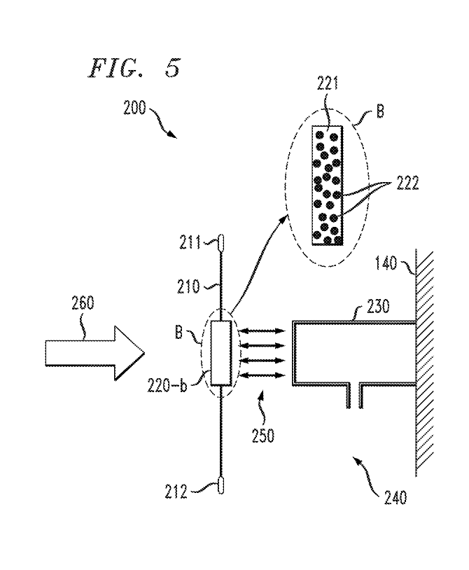

FIG. 4 illustrates a schematic example of a cell 200 for use in a metamaterial structure which may be employed in the composite material 100 according to some embodiments. Unless otherwise indicated, like elements in FIG. 4 have been provided with like reference numerals as those of FIGS. 2 and 3.

Referring to FIG. 4, cell 200 comprises an elastic membrane 210, a mass element 220-a which may be a small plate-like body (i.e. a platelet) embedded on the membrane 210, a resonator 230 mounted on a hard surface 140 where an air gap 240 is present surrounding the resonator 230. Except for the specific features described below, the structural and operational characteristics of the cell 200 of FIG. 4 are similar to that of the cell 200 of FIG. 2; therefore additional description thereof is considered not necessary.

In the embodiment of FIG. 4, the cell 200 makes use of a magnetic interaction between a fixed magnet 253 and a magnetic or ferrous mass element 220-a The fixed magnet 253 may be added to the resonator structure 230, and therefore the motion of the mass element 220-a relative to the fixed magnet 253 may be affected by the magnetic force between mass element 220-a and fixed magnet 253. The resulting effect is that the oscillation of the membrane 210 is damped. This in turn may modify the flexural response of the membrane and hence the absorption characteristics of the material. A multiple degree-of-freedom set-up could be introduced using cells 200 with different magnetic field intensities and to generate more complex motions (translational and rotational) of the mass element 220-a relative to the fixed magnet 253. This will change the number of possible modes of flexural vibration as well as the frequency response of the membrane, which will in turn affect the absorption response of the metamaterial 131. Therefore, at specific modal excitation frequencies, energy from the incident sound will be trapped inside the cell 200 and dissipated via viscous dissipation in the membrane.

Similar to the embodiment of FIG. 3, the resonator 230 may be used to further absorb the acoustic noise at frequencies which are different from the resonance frequency of the resonator 230. The frequency response of the resonator 230 may be tuned depending on the resonator geometry to maximize absorption in a desired frequency range, particularly at frequencies where it is predicted that the membrane 210 may not act as an effective absorber.

In some embodiments, a pair of magnets may be used to ensure that the membrane 210 is maintained in equilibrium position when no sound waves are present. For example, a first hollow and cylindrical magnetic may be provided adjacent to the resonator 230 and an identical hollow and cylindrical magnet may be provided on the side of the membrane 210 which is opposite to the resonator 230. This would impart some symmetry in the system normal to the plane of the membrane 230, in that at rest the ferrous mass element 220-a would experience a neutral force on it, thus standing in equilibrium.

FIG. 5 illustrates a schematic example of a cell 200 for use in a metamaterial structure which may be employed in the composite material 100 according to some embodiments. Unless otherwise indicated, like elements in FIG. 5 have been provided with like reference numerals as those of FIGS. 2-4.

Referring to FIG. 5, cell 200 comprises an elastic membrane 210, a mass element 220-b which may be a small plate-like body (i.e. a platelet) embedded on the membrane 210, a resonator 230 mounted on a hard surface 140 where an air gap 240 is present surrounding the resonator 230. Except for the specific features described below, the structural and operational characteristics of the cell 200 of FIG. 3 are similar to that of the cell 200 of FIG. 2; therefore additional description thereof is considered not necessary.

In the embodiment of FIG. 5, the mass element 220-b is hollow and may contain a fluid 221, suspended particles 222 or a combination thereof as shown in the enlarged detailed illustration B of the mass element 220-b.

Therefore, in an example embodiment of FIG. 5 where both a fluid and plurality of particles are provided inside a hollow mass element 220, the dynamics of the interior of the mass element 220-b may comprise the drag effect of the particles 222 within the fluid 221 and the motion of the fluid itself. Therefore, as the membrane 210 oscillates in response to an incident sound wave 260, the mass element 220-b oscillates as well. This will cause the fluid 221 and the particles 222 to move inside the mass element 220-b and thus affecting the overall dynamic movement of the mass element 220-b which may result in dampening the oscillation of the membrane 210. This in turn may modify the flexural response of the membrane 131 and hence the absorption characteristics of the material. Adding hollow platelets in this way presents an additional degree of freedom, which may be beneficial if targeting a specific absorption response for a given application.

In some embodiments, instead of a fluid, a viscoelastic material may be used. One example of such material is rubber. In such cases, similar to the use of fluid, the movement of the viscoelastic material inside the mass element 220-b may affect the overall dynamic movement of the mass element 220-b which may result in dampening the oscillation of the membrane 210

In some embodiments, the hollow mass element 220-b is made of a compliant plastic matrix that approximately locks in plastic particles while it allows the particles to locally vibrate or oscillate as the hollow mass element 220-b oscillate.

A multiple degree-of-freedom set-up could be introduced using mass elements 220-b with different fluid/particle characteristics to generate more complex motions (translational and rotational) of the mass element 220-b in each cell 200. This will change the number of possible modes of flexural vibration as well as the frequency response of the membrane, which will in turn affect the absorption response of the metamaterial 131. Therefore, at specific modal excitation frequencies, energy from the incident sound will be trapped inside the cell 200 and dissipated via viscous dissipation in the membrane.

In some embodiments the mass element may only contain fluid or it may only contain particles. In these cases, the movement of the fluid 221 or the particles 222 inside the mass element 220-b may affect the overall dynamic movement of the mass element 220-b resulting in dampening the oscillation of the membrane 210.

Similar to the embodiments of FIGS. 3 and 4, the resonator 230 may be used to further absorb the acoustic noise at frequencies which are different from the resonance frequency of the resonator 230. The frequency response of the resonator 230 may be tuned depending on the resonator geometry to maximize absorption in a desired frequency range, particularly at frequencies where it is predicted that the membrane 210 may not act as an effective absorber.

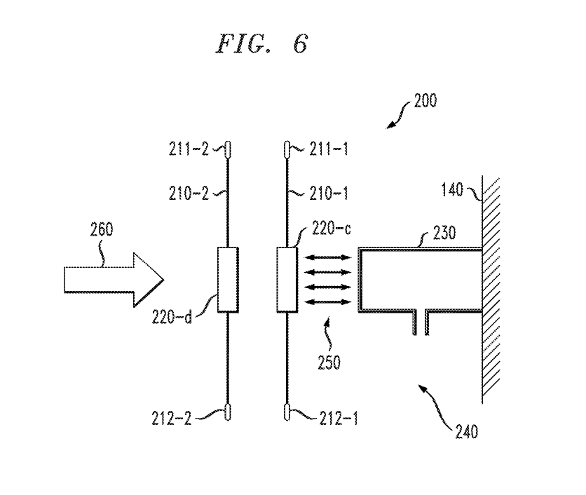

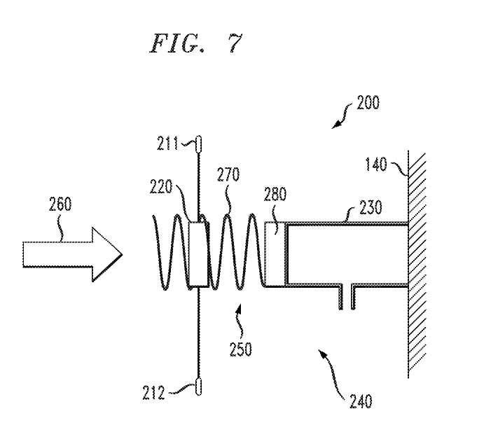

FIG. 6 illustrates a schematic example of a cell 200 for use in a metamaterial structure which may be employed in the composite material 100 according to some embodiments. Unless otherwise indicated, like elements in FIG. 6 have been provided with like reference numerals as those of FIGS. 2-5.

Referring to FIG. 6, cell 200 comprises at least two elastic membranes 210-1 and 210-2, at least two embedded mass elements 220-c and 220-d each of which may be a small plate-like body (i.e. a platelet) and each embedded on a respective elastic membrane 210-1 and 210-2, a resonator 230 mounted on a hard surface 140 where an air gap 240 is present surrounding the resonator 230. Except for the specific features described herein with reference to FIG. 6, the structural and operational characteristics of the cell 200 of FIG. 6 are similar to that of the cell 200 of FIG. 2; therefore additional description thereof is considered not necessary.

In the embodiment of FIG. 6, instead of one, two mass elements 220-c and 220-d are used. However, the disclosure is not so limited and other numbers of such mass elements may also be employed within the scope of the present disclosure.

Therefore, in the embodiment of FIG. 6, the damping effect provided by the membrane and mass element as described with reference to FIG. 2 is now present with respect to two (or more) pairs of membrane/mass element. In this embodiment, a first layer comprises a first membrane 210-1 having a first mass element 220-c embedded thereon may be designed to oscillate at a first frequency whereas a second layer comprises a second membrane 210-2 having a second mass element 220-c embedded thereon may be designed to oscillate at a second frequency. As such, these two layers may therefore each absorb frequencies out of the range of their respective resonance frequencies and therefore provide absorption in additional frequency ranges.

This embodiment adds an additional number of degrees of freedom which may be beneficial in mitigating the effect of anti-resonance modal excitation. Indeed in some cases it may occur that using only one membrane/mass layer may result in that sound may be substantially or even wholly reflected at certain frequencies by the single layer of membrane/mass. This would therefore limit the overall absorption capability at the system.

By using the multi-layer solution as provided in the embodiment of FIG. 6, a layer may be designed so that it has a resonance frequency which corresponds to the anti-resonance frequency of another layer. Furthermore, designing two (or more) layers with different properties may increase the number of resonant modal excitation frequencies thereby increasing the bandwidth of the acoustic noise absorption provided by the metamaterial 131.

In some embodiments, the mass elements 220-c and 220-d on the two (or more) layers may be mechanically coupled to one another. This may provide additional degrees of freedom in the response of the metamaterial 131, allowing additional tenability in the flexural response of the system. The mechanical coupling between the two (or more layers) may be achieved by any one of the techniques described with reference to the previous embodiments of FIGS. 3-5 or a combination thereof.

Furthermore, mass elements and membranes of different characteristics and properties may be used in both layers thus providing additional ranges in acoustic noise absorption.

Similar to the embodiments of FIGS. 3-5, the resonator 230 may be used to further absorb the acoustic noise at frequencies which are different from the resonance frequency of the resonator 230. The frequency response of the resonator 230 may be tuned depending on the resonator geometry to maximize absorption in a desired frequency range, particularly at frequencies where it is predicted that the membranes 210-1 and 210-2 may not act as an effective absorbers.

FIG. 7 illustrates a schematic example of a cell 200 for use in a metamaterial structure which may be employed in the composite material 100 according to some embodiments. Unless otherwise indicated, like elements in FIG. 7 have been provided with like reference numerals as those of FIGS. 2-6.

Referring to FIG. 7, cell 200 comprises an elastic membrane 210, a mass element 220-e which may be a small plate-like body (i.e. a platelet) embedded on the elastic membrane 210, a resonator 230 mounted on a hard surface 140 where an air gap 240 is present surrounding the resonator 230. Except for the specific features described herein with reference to FIG. 7, the structural and operational characteristics of the cell 200 of FIG. 7 are similar to that of the cell 200 of FIG. 2; therefore additional description thereof is considered not necessary.

In this embodiment, the mass element 220-e is magnetic, e.g. a permanent magnet, and a conductive coil 270 in provided in the cell 200 which surrounds the mass element 220-e. The conductive coil may be attached on and supported by the housing of the resonator 230 or any other support such as the hard surface 140.

As the membrane 210 oscillates in response to an incident sound wave thereby causing the magnetic mass element 220-e to oscillate, the movement of the magnetic mass element induces a current inside the coil 270. The benefits of this embodiment are two-fold; on the one hand this arrangement provides the ability of using the composite material 100 for the purpose of harvesting energy from the acoustic noise by using an energy harvesting circuitry 280 to collect the generated electric energy; and on the other, the arrangement enables magnetic damping which contributes to the absorption of the acoustic noise by the system as it may remove kinetic energy from the magnet/coil pair and heat the conductive coil, which may affect the flexural response of the system. In particular as the magnet moves relative to the conductor coil, a back electromagnetic force is induced which may dampen the motion of the spring (i.e. kinetic energy is converted into heating of the conductor). This damping is advantageous, as it may change the resonant behavior of the system from a high-Q (low damping response) narrowband acoustic noise absorber to a low-Q (high damping response), wider-band acoustic noise absorber. This could be beneficial in applications which require wideband acoustic noise to be absorbed.

Similarly, the harvested energy in the embodiment of FIG. 7 may be used in an active-feedback/feedforward control arrangement where, for example, overall arrangement comprising the membrane 210, mass element 220-e and the resonator 230 may be tuned to optimize the flexural response of the membrane (and hence the absorption) to the incident sound wave 260.

An additional embodiment with reference to FIG. 7 may use a resistor (not explicitly shown) instead of the energy harvester 280, wherein the resistor would provide an additional mechanism for dissipation of the harvested energy in the form of heat.

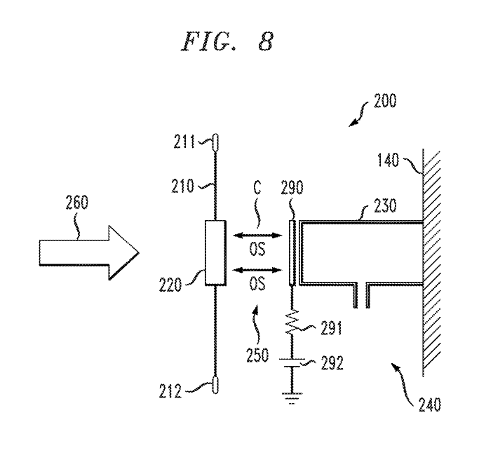

FIG. 8 illustrates a schematic example of a cell 200 for use in a metamaterial structure which may be employed in the composite material 100 according to some embodiments. Unless otherwise indicated, like elements in FIG. 8 have been provided with like reference numerals as those of FIGS. 2-7.

Referring to FIG. 8, cell 200 comprises an elastic membrane 210, a mass element 220 which may be a small plate-like body (i.e. a platelet) embedded on the elastic membrane 210, a resonator 230 mounted on a hard surface 140 where an air gap 240 is present surrounding the resonator 230. Except for the specific features described herein with reference to FIG. 8, the structural and operational characteristics of the cell 200 of FIG. 8 are similar to that of the cell 200 of FIG. 2; therefore additional description thereof is considered not necessary.

In this embodiment, the mass element 220 is an electric conductor and the cell 200 further comprises an additional electric conductor 290. The two electric conductors 220 and 290 form respective electrodes of a capacitor C. For a more simplified use of terminology when referring to the two electric conductors 220 and 290, electric conductor 220 will be referred to as the mass element and electric conductor 290 will be referred to as the conductor.

Preferably conductor 290 is electrically connected to a terminal of an electric energy dissipater 291, e.g. an electric resistor. Alternatively, the mass element 220 may be connected to an electric energy dissipater (not explicitly shown in FIG. 8).

The capacitor C and energy dissipater 291 may therefore form an electric circuit, e.g. an RC circuit in case of using a resistor as electric energy dissipater. An electric power supply 292, i.e. voltage or current source, may be used to supply the required electric energy for the electric circuit.

In operation, the elastic membrane 210 oscillates in response to incident sound waves 260. This causes the mass element 220 to oscillate s shown by arrows OS. The oscillation of the mass element 220 relative to the electrode 290 (with the presence of the power supply 290) causes changes in the charge stored in the electrode 290 according to the well-known properties of a capacitor. This change in charges induces an oscillating current through the electric energy dissipater 291 thereby dissipating the energy in the form of heat.

Similar to the embodiments described above, the resonator 230 may be used to further absorb the acoustic noise at frequencies which are different from the resonance frequency of the resonator 230. The frequency response of the resonator 230 may be tuned depending on the resonator geometry to maximize absorption in a desired frequency range, particularly at frequencies where it is predicted that the membrane 210 may not act as an effective absorber.

The above embodiments therefore provide various manners of providing an article and a composite material 100 for efficient absorbing acoustic noise. The various embodiments of the present disclosure may be combined as long as such combination is compatible and/or complimentary.

The absorption response of the composite material 100 as proposed herein may also be tunable to various ranges of frequencies so that the composite material can be optimally absorbent at a frequency range of interest. This tunability may be obtained in a variety of ways, such as for example: varying the tension of the membrane 210, the densities and geometries of the embedded masses 220 on the metamaterial, the size of the air gap 240, and the geometries of the resonator arrays 230. The thickness of the bulk absorptive layer 120 may affect the overall performance in the mid-high frequency range, but also contributes to the overall thickness of the composite. Therefore some of the performance provided by the bulk absorptive layer may be sacrificed if the volume requirements of the application are more stringent.

When mitigating fan noise for example, it is beneficial to achieve maximum absorption in the frequency range close to the fan blade-pass frequency. The blade-pass frequency (BPF) is related to the number of fan blades and rotational speed, and is caused by periodic noise generation between the fan blades and solid obstructions such as stator vanes and struts in close proximity to the fan blades. This generated noise is typically significant as it may constitute up to 15% of the total sound energy generated by the fan(s) and is contained in the fundamental blade-pass tone. Significant broadband noise is also generated at frequencies close to the BPF much of which is the low-frequency region (<1 kHz). This range of frequencies may targeted to be absorbed by the third layer comprising the membrane-type metamaterial structure 131 and the backing air gap structure 132 as described above.

Another important advantage of the solution proposed herein is that it provide a reliable and passive acoustic noise mitigation across a very broad frequency range with a minimal addition in volume.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

The described embodiments are to be considered in all respects as only illustrative and not restrictive. In particular, the scope of the disclosure is indicated by the appended claims rather than by the description and figures herein. All changes that fall within the meaning and range of equivalency of the claims are to be embraced within their scope.

It should be appreciated by those of ordinary skill in the art that any block diagrams herein represent conceptual views of illustrative circuitry embodying the disclosed principles.

What is claimed is:

1. An article comprising: an article comprising:
an elastic membrane having a mass element provided thereon, the mass element having an asymmetric shape; and
a resonator structure being totally or partially hollow and located between a hard surface and the mass element, the resonator structure having a resonance frequency;
wherein the elastic membrane is configured to oscillate in response to a sound wave incident thereon, and the asymmetry of the mass element is configured to induce a flapping motion which in combination with the oscillation of the membrane trap vibrational mechanical energy from the sound wave; and
wherein the resonator structure is configured to absorb at least a part of the incident sound wave.

2. The article of claim 1, wherein the article comprises a surface configured to reflect incident sound waves towards the resonator and the elastic membrane.

3. The article of claim 1, wherein the article comprises a dampener configured to cooperate with the spring to damp the oscillation of the membrane.

4. The article of claim 1, wherein the mass element is magnetic or ferrous and the article comprises a fixed magnet; wherein the article is configured to damp a motion of the mass element relative to the fixed magnet by an effect of a magnetic force between the mass element and the fixed magnet.

5. The article of claim 1, wherein the mass element is hollow and comprises at least one of a fluid, a viscoelastic material and a plurality of suspended particles, the article being configured to damp a motion of the mass element by a drag effect caused by the fluid, the viscoelastic material, the plurality of suspended particles, or a combination thereof.

6. The article of claim 1, wherein the article comprises at least two elastic membranes each having a respective mass element thereon, wherein a first elastic membrane is configured to oscillate at a first resonant oscillation frequency in response to an acoustic wave incident thereon and a second elastic membrane is configured to oscillate at a second resonant oscillation frequency in response to an acoustic wave incident thereon, and wherein said first resonant oscillation frequency is different from said second resonant oscillation frequency.

7. The article of claim 6, wherein the mass element of the first elastic membrane is mechanically coupled to the mass element of the second elastic membrane.

8. The article of claim 6, wherein the mass element of the first elastic membrane has physical characteristics that are different from physical characteristics of the mass element of the second elastic membrane.

9. The article of claim 1, wherein the mass element is magnetic and the article further comprises a conductive coil at least partially surrounding the mass element; wherein the article is configured to induce a current inside the coil in response to an oscillation of the magnetic mass element provided on the membrane.

10. The article of claim 9, wherein further comprising an energy harvester circuit configured to collect electric energy produced by the induction of current in the coil.

11. The article of claim 9, wherein the induction of current in the coil is dissipated as heat in the coil.

12. The article of claim 9, wherein the article comprises a resistor electrically connected to the coil and configured to dissipate the electric energy through heat.

13. The article of claim 1, wherein the mass element is a first electric conductor and the article further comprises a second electric conductor, wherein the first electric conductor and the second electric conductor form respective electrodes of a capacitor and the article further comprises an electric energy dissipater and an electric power supply the capacitor is configured to produce a change in charge stored in the first electrode and the second electrode, wherein such change in charge induces an oscillating current through the electric energy dissipater thereby dissipating the energy in the form of heat.

14. The article of claim 1, wherein the elastic membrane is attached at end regions thereof to a supporting frame structure.

15. The article of claim 1, wherein the elastic membrane is attached to one or more adjacent elastic membranes.

16. The article of claim 1, wherein the elastic membrane comprises perforations to allow pressure relief and/or viscous dissipation from air movement through the perforations.

17. A composite material, comprising:
a layer of an acoustically transparent, airflow resistant material configured for preventing penetration of airflow;
a layer of bulk absorptive material configured to absorb noise in a first frequency range
a layer comprising an article, including:
an elastic membrane having a mass element provided thereon, the mass element having an asymmetric shape; and
a resonator structure being totally or partially hollow and located between a hard surface and the mass element, the resonator structure having a resonance frequency;
wherein the elastic membrane is configured to oscillate in response to a sound wave incident thereon, and the asymmetry of the mass element is configured to induce a flapping motion which in combination with the oscillation of the membrane trap vibrational mechanical energy from the sound wave; and
wherein the resonator structure is configured to absorb at least a part of the incident sound wave.

18. The composite material of claim 17, wherein the bulk absorptive material comprises a second resonator structure configured to absorb the incident sound wave.

19. The composite material of claim 17, wherein the elastic membrane comprises perforations configured to allow for pressure relief and/or viscous dissipation from air movement through the perforations.

20. The composite material of claim 17, wherein the composite material comprises a hard surface provided at a location downstream the layer comprising an article in a direction of propagation of the sound waves.

21. The composite material of claim 20, wherein the hard surface comprises perforations configured to allow for pressure relief.
